(19) United States
(12) Patent Application Publication
(10) Pub. No.: US 2016/0039539 A1
(43) Pub. Date: Feb. 11, 2016

(54) METHODS AND APPARATUS FOR AIRCRAFT BOARDING

(71) Applicant: Rectrix Commercial Aviation Services Inc., Concord, MA (US)

(72) Inventor: RICHARD CAWLEY, Sherborn, MA (US)

(73) Assignee: Rectrix Commercial Aviation Services Inc., Concord, MA (US)

(21) Appl. No.: 14/729,304

(22) Filed: Jun. 3, 2015

Related U.S. Application Data
(60) Provisional application No. 62/033,807, filed on Aug. 6, 2014.

(51) Int. Cl. B64F 1/30; G09F 1/00

(52) U.S. Cl. CPC B64F 1/30; G09F 1/00

(57) ABSTRACT

A passenger boarding procedure is disclosed which eliminates disadvantages associated with conventional techniques. In some embodiments, passengers may be physically arranged in a pre-boarding waiting area largely as they would be seated on the aircraft. When boarding commences, passengers with assigned seats in the row at the back of the plane are allowed to board first. These passengers may board so that those who have been assigned window seats sit down first, followed by those who have been assigned middle seats (if present), followed by those who have been assigned aisle seats (if present). The passengers who have been assigned seats in the next rear-most row may then board the aircraft, sitting down in the same order as those who previously boarded, and this procedure is repeated until all passengers have boarded. Physical articles and other apparatus are disclosed for facilitating the boarding procedure.

### RELATED APPLICATION

This application claims priority under 35 U.S.C. §119(e) to U.S. Provisional Application Ser. No. 62/033,807, entitled “AIRCRAFT BOARDING PROCEDURE,” filed on Aug. 6, 2014, which is incorporated by reference herein in its entirety.

### FIELD

This invention relates to boarding passengers on aircraft.

### BACKGROUND

In January 2014, the Federal Aviation Administration (FAA) enacted rules which limit the amount of time that pilots can be continuously on duty without having rested. Specifically, these rules require pilots to get a minimum amount of uninterrupted rest between shifts (at least ten hours, at least eight of which must involve uninterrupted sleep), and limit the number of consecutive hours that pilots can be on duty (shifts are limited to eight or nine hours, depending on a pilot's start time). These rules also specify that pilots must also have thirty consecutive hours of rest each week, a twenty-five percent increase over the amount previously required.

### SUMMARY

The Assignee has appreciated that minimizing the amount of time that passengers take to board an aircraft may have numerous positive effects. For example, completing the boarding process as fast as possible may enable a flight crew to complete more flights in a given shift or time period, enabling the airline to more effectively manage personnel costs. Additionally, during times of the day when aircraft operated by different airlines are all being boarded at around the same time (e.g., early in the morning), completing the passenger boarding process more quickly may allow the aircraft to get in line to take off more quickly, thereby allowing the airline to more effectively manage airport costs, and may reduce the amount of time that the aircraft waits for clearance to take off, thereby reducing fuel costs. Enabling flights to take off more quickly may also increase customer satisfaction with not just the boarding process but the flight experience overall. Further, minimizing the amount of time that an aircraft spends on the runway or tarmac idling while waiting to take off can reduce the aircraft's impact on the environment.

Additionally, the risks associated with not minimizing the amount of time that passengers take to board an aircraft may be exacerbated by the FAA rule changes summarized above. For example, crew shift time limits create the risk that passenger boarding delays may cause a flight crew to “time out” (i.e., be unable to complete a flight about to take off because doing so would cause the pilot to exceed a shift limit), such that the airline may be forced to call in a “relief” crew to complete the flight, which could be very disruptive and cause significant further delays. With the additional risk of weather-related delays to consider as well, boarding passengers as quickly as possible has become exceedingly important.

Accordingly, some embodiments of the invention are directed to a method of boarding passengers on an aircraft. The aircraft has a plurality of seats arranged in a plurality of seat rows. Each of the passengers has been assigned one of the plurality of seats. The plurality of seat rows comprise a rear-most seat row that, among the plurality of seat rows, is closest to the rear of the aircraft, and a front-most seat row that, among the plurality of seat rows, is closest to the front of the aircraft. The method comprises acts of: (A) physically arranging the passengers so that each passenger occupies one of a plurality of spaces, each of the spaces corresponding to one of the plurality of seats on the aircraft, the spaces being arranged in a plurality of rows, each of the plurality of rows corresponding to one of the seat rows on the aircraft, each of the spaces being located within one of the plurality of rows in a location similar to the location of the corresponding seat within the corresponding seat row on the aircraft; (B) causing the passengers occupying the spaces corresponding to the seats in the rear-most seat row to board the aircraft; (C) at a time subsequent to the time at which the act (B) commences, causing the passengers occupying the spaces corresponding to the seats in the next rear-most seat row to board the aircraft; and (D repeating the act (C) until the passengers occupying the spaces corresponding to the seats in the front-most seat row have boarded the aircraft. The act (A) may, for example, comprise employing at least one physical article depicting the plurality of spaces to physically arrange the passengers. The act (A) may, for example, comprise employing a light-emitting apparatus to emit visible light so as to define the plurality of spaces. The act (B) may, for example, comprise causing the passengers occupying the spaces corresponding to the seats in the rear-most seat row to sit down in the aircraft so that any of the passengers assigned window seats sit down first, any of the passengers assigned middle seats sit down after the passengers assigned window seats sit down, and any of the passengers assigned aisle seats sit down after the passengers assigned middle seats sit down.

Some embodiments of the invention are directed to at least one physical article for use in boarding passengers on an aircraft having a plurality of seats arranged in a plurality of seat rows. The at least one article comprises a representation portrayed thereon of each of the plurality of seats on the aircraft. The representations of the plurality of seats are arranged in a plurality of rows. Each of the plurality of rows corresponds to one of the seat rows on the aircraft. Each representation of a seat is located within one of the plurality of rows in a location similar to the location of the corresponding seat within the corresponding seat row on the aircraft.

Some embodiments of the invention are directed to an apparatus for use in boarding passengers on an aircraft having a plurality of seats arranged in a plurality of seat rows. The apparatus comprises at least one light-emitting element configured to emit visible light toward a surface; and at least one computer processor programmed to cause the at least one light-emitting element to emit light so as to define a plurality of spaces on the surface. Each of the plurality of spaces corresponds to one of the plurality of seats on the aircraft. The plurality of spaces is arranged in a plurality of rows. Each of the plurality of rows corresponds to one of the seat rows on the aircraft. Each space is located within one of the plurality of rows in a location similar to the location of the corresponding seat within the corresponding seat row on the aircraft.

Some embodiments of the invention are directed to at least one computer-readable storage medium having instructions encoded thereon which, when executed, cause a computer to perform a method which comprises causing at least one light-emitting element to emit visible light toward a surface so as to define a plurality of spaces on the surface. Each of the plurality of spaces corresponds to one of the plurality of seats on an aircraft. The plurality of spaces is arranged in a plurality of rows. Each of the plurality of rows corresponds to one of a plurality of seat rows on the aircraft. Each space is located within one of the plurality of rows in a location similar to the location of the corresponding seat within the corresponding seat row on the aircraft.

The foregoing is a non-limiting summary of certain aspects of the invention, some embodiments of which are set forth in the appended listing of claims.

### BRIEF DESCRIPTION OF DRAWINGS

The accompanying drawings are not intended to be drawn to scale. In the drawings, each identical or nearly identical component illustrated in the various figures is represented by a like numeral. For purposes of clarity, not every component may be labeled in every drawing. In the drawings:

FIG. 1 is a representative seat map of a commercial aircraft;

FIG. 2 illustrates a representative boarding technique, in accordance with some embodiments of the invention;

FIG. 3 depicts an article which may be used to facilitate passengers boarding an aircraft in a particular order, in accordance with some embodiments of the invention;

FIG. 4 depicts articles which may be used to facilitate passengers boarding an aircraft in a particular order, in accordance with some embodiments of the invention;

FIG. 5 is a depiction of a lighting arrangement for creating a display which may be used to facilitate passengers boarding an aircraft in a particular order, in accordance with some embodiments of the invention;

FIG. 6 is a block diagram depicting a representative computer system which may be used to implement aspects of some embodiments of the invention.

### DETAILED DESCRIPTION

Minimizing the amount of time that passengers take to board an aircraft offers many advantages. For example, reducing the amount of time needed to complete the boarding process may enable a flight crew to complete more flights in a given shift or time period, allowing the airline to more effectively manage personnel costs. For example, assume that a particular pilot is scheduled to perform two flights in a particular day, and the first flight is delayed for some reason (e.g., due to weather, air traffic control, congestion, etc.). As noted above, the FAA defines a maximum amount of time that the pilot can remain on duty in a given day, and so the delay causes the first flight to consume more of that total duty time than originally planned. The FAA also requires that her second flight be scheduled to complete within her remaining duty time for the day. As a result, boarding passengers on the second flight as quickly as possible becomes very important, as the boarding time may determine whether the pilot is able to take off on the second flight, or whether the airline is forced to call in another pilot to perform the second flight. Of course, having to call in a new pilot may cause delays, increase the airline's costs, and (if delays of this type occur often) have a significant adverse effect on the airline's commercial reputation.

Additionally, quickly completing the boarding process may allow airlines and airports to more effectively manage scarce resources, which can have a number of positive downstream consequences. For example, during times of the day when many aircraft operated by different airlines are all being boarded at around the same time (e.g., early in the morning), quickly completing the boarding process may allow an aircraft to get in line to take off more quickly, thereby reducing the airline's airport costs, and reduce the amount of time that the aircraft sits on the runway waiting for clearance to take off, thereby reducing the airline's fuel costs and the aircraft's effect on the environment. In this respect, many airports allot time slots during which flights may take off and land. Given the large number of flights that many airports service, and the potential for congestion during certain times of the day, these time slots can be scarce, and so it is very important that a flight stick to its allotted time slot for takeoff and landing. If it does not, the flight may disrupt a number of subsequently scheduled takeoffs and/or landings, and/or be substantially delayed itself. For example, it is not uncommon for an aircraft to circle above an airport for a substantial amount of time waiting for a landing time slot to open up because it or another flight missed its originally allotted time slot and caused delays.

Also, another scarce resource is airport gates to accommodate passengers prior to takeoff and after landing. If a flight which is scheduled to use a particular gate takes off or lands late because the boarding process took longer than necessary, then other flights which are scheduled to use that gate afterward may be pushed back, thereby delaying airport traffic overall.

Additionally, given that many flights are connecting flights (i.e., flights with passengers who plan to board subsequent flights shortly after landing at a destination airport), delays in the boarding process at an originating airport may cause passengers to then have to race through the destination airport to catch a subsequent flight, or miss the subsequent flight altogether. This is clearly less than ideal.

It should also be appreciated that the delays and other consequences caused by the boarding process taking longer than necessary are not just mere inconveniences, and can affect passenger safety and aircraft maintenance. For example, it is not uncommon for a flight to be scheduled to land at an airport a short time before a storm system is due to arrive. If the flight takes longer than necessary to board before taking off, then the aircraft may be forced to land at its destination during a storm, which can compromise the safety of both passengers and crew. In addition, many airlines allot a specific amount of overall service time to an aircraft before it is to be taken out of service for scheduled maintenance, so delays in the boarding process each time the aircraft flies can unnecessarily consume that service time. This can increase costs borne by the airline—i.e., costs which are often passed along to passengers.

Thus, it can be seen that taking no longer than necessary to board an aircraft may have numerous positive effects, and mitigate, if not eliminate, many potential negative consequences.

Airlines conventionally use a number of different procedures to board passengers on an aircraft at a commercial airport. For example, many airlines use the “back to front” method, whereby passengers who have been assigned seats in a group of rows near the back of the plane board first, then passengers in the next few rear-most rows, and so on, gradually working toward the front of the airplane. Using the representative seat map shown in FIG. 1 to illustrate, using this method, passengers with assigned seats in rows R25-R29 may be allowed to board first, followed by passengers in rows R21-R25, then by passengers in rows R16-R20, and so on until all of the passengers seated in rows R6-R29 have been seated. (Airlines typically allow first class and/or business class passengers, seated in rows R1-R5 in the representative seat map shown in FIG. 1, to board prior to the passengers with assigned seats near the rear of the plane.) One problem with the “back to front” method is that passengers tend to spend a lot of time waiting in the aisle (i.e., located between seats C and D in each row in the representative seat map of FIG. 1) to sit down in their seat. This is because when a passenger arrives at the row of seats to which they have been assigned, often there is another person already seated in that row that is blocking the passenger's path to his/her seat. For example, the passenger seated in seat R29A in may arrive at row R29 to find another passenger already seated in seat R29B. When that happens, the passenger in R29B typically gets up and vacates the row to allow the passenger in seat R29A to sit down. Because many of the people trying to board the aircraft at any particular time are trying to access the same few rows (and the same few overhead bins), delays often occur.

Another boarding procedure used by airlines today is the “random method,” which involves letting people get on the plane in an order unrelated to their assigned seats. For example, some airlines allow passengers to board the aircraft in the order they checked in at the gate. The “random method” is often faster than the “back to front” method because at any given time, passengers boarding the plane are not trying to sit down in the same few rows and access the same few overhead bins. However, congestion in the aisle may still arise if a passenger with an assigned seat in a row arrives at the row to find that another person is blocking his/her path to the seat. Using FIG. 1 to illustrate, a passenger a passenger with assigned seat R25F may arrive at row R25 to find another passenger already sitting in seat R25E, such that the passenger in seat R25E typically gets up, vacates the row, allows the person in seat R25F to sit, and then sits down again.

Yet another boarding procedure used today is the “outside in” method, and involves passengers with window seats (i.e., in FIG. 1, seats A and F in each row) boarding first, regardless of row, followed by all passengers with middle seats (i.e., in FIG. 1, seats B and E in each row), and then all people with aisle seats (i.e., in FIG. 1, seats C and D in each row). This method typically reduces congestion in the aisle because at the time each passenger sits down, usually there is no one blocking access to his/her seat. Because the passengers boarding the plane at any given time aren't all trying to access the same few rows and the same few overhead bins, passengers may sit down simultaneously with minimal delay. However, one disadvantage to this method is that groups of passengers in contiguous blocks of seats (e.g., families with small children) can't board at the same time. Some airlines make exceptions and allow some groups of passengers to board together, which can cause delays.

Another technique in use today involves passengers boarding the aircraft in the order in which they check in at the gate, but with no seat having been assigned to them. One advantage of this method is that passengers spend relatively little time waiting in the aisle to access their seat, because if a passenger encounters congestion in the aisle, he/she may just sit down in the row at which they are standing rather than waiting to get past. However, one disadvantage to this method is that some passengers may get anxious about having to choose their own seat, and may dislike having to stand in line after checking in waiting for the chance to board the aircraft. Additionally, groups of passengers who wish to sit together may find it difficult to find contiguous blocks of seats, particularly if they were among the last to board the aircraft.

Some embodiments of the present invention provide a boarding procedure which eliminates many of the disadvantages of the conventional techniques described above. This boarding procedure allows passengers to board an aircraft quickly, while also not preventing groups of passengers from boarding together.

In accordance with some embodiments of the invention, passengers may be physically arranged in the pre-boarding waiting area in one or more groups, with the passengers in each group being arranged largely as they would be seated on the aircraft. Then, when boarding commences, passengers with assigned seats in the row at the back of the plane are allowed to board first. These passengers may, for example, board the aircraft so that those who have been assigned window seats sit down first, followed by those who have been assigned the middle seats (if present), followed by those who have been assigned the aisle seats (if present). The passengers who have been assigned seats in the next rear-most row board the aircraft next, sitting down in the same order as those who previously boarded. This procedure continues until all passengers have boarded the aircraft. Using this procedure, passengers spend little time, if any, waiting in the aisle for another passenger in front of them to sit down or perform other activities related to boarding the aircraft (e.g., loading a bag into an overhead bin), and so passengers may board the aircraft quickly.

Passengers may be physically arranged in the pre-boarding waiting area as they would be seated on the aircraft in any of numerous ways. In one example, one or more articles (e.g., drop cloths, rugs, laminated sheets, and/or any other article(s) suitable for laying on the floor of the waiting area) may be used to depict the seats of the aircraft to be boarded, and may provide a designated space corresponding to each seat on the aircraft. The space corresponding to each seat may be large enough to allow the passenger assigned to the corresponding seat to stand in it, and each passenger may be asked to stand in the space corresponding to his/her assigned seat prior to boarding. Once passengers are arranged as they would be seated on the aircraft, they may board the aircraft according to the procedure outlined above.

It should be appreciated that embodiments of the invention are not limited to employing a physical article to aid in arranging passengers generally as they would be seated on the aircraft. For example, a lighting system designed to assist in boarding aircraft may include lighting elements configured to create (e.g., by projecting or otherwise emitting visible light) a representation of seats of the aircraft (e.g., on the floor of the pre-boarding waiting area), with a designated space for each seat on the aircraft. Each space may be large enough to allow a passenger assigned to the corresponding seat to stand in or near it, and each passenger with an assigned seat on the aircraft may be asked to stand near the space corresponding to the seat prior to boarding.

In another example, passengers may be physically arranged in the waiting area as they would be seated on the aircraft without the aid of a physical article or lighting system. For example, before boarding is to begin, airline employees may ask passengers to line up in rows generally as they would be seated on the airplane, and then dispatch passengers on to the aircraft by row. Any of numerous techniques may be employed to arrange passengers in the pre-boarding waiting area largely as they would be seated on the aircraft, and embodiments of the invention are not limited to any particular mode of implementation.

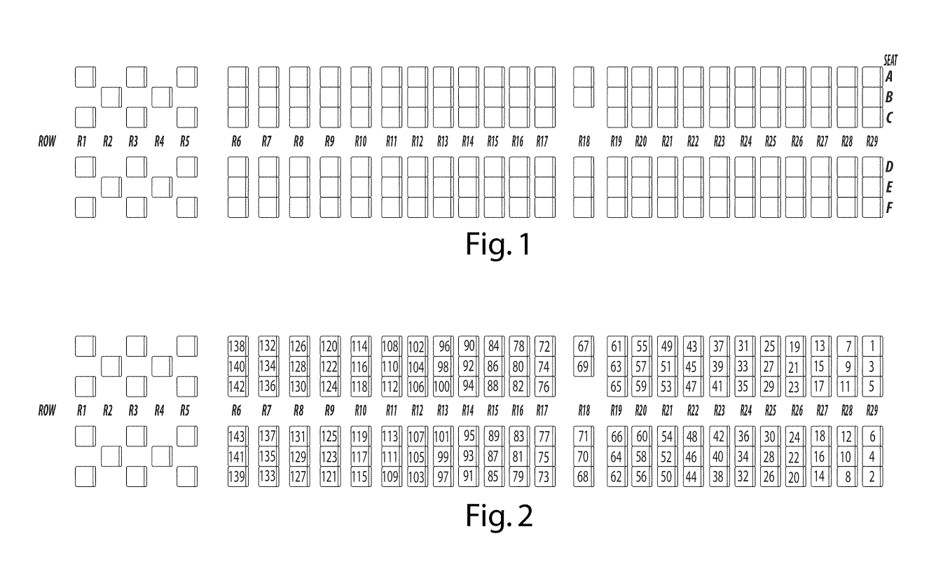

FIG. 2 illustrates a representative technique for boarding an aircraft in accordance with some embodiments of the invention. This technique is illustrated in FIG. 2 using the seat map shown in FIG. 1, although it should be appreciated that the technique shown may be used to board aircraft having any suitable configuration, having any suitable number of rows of seats to board, and having any suitable number of seats in each row.

In FIG. 2, the numerals within the seat icons represent the order in which passengers in these seats are boarded. Thus, the number 1 indicates the first passenger to board the plane, the number 2 indicates the second passenger to board the plane, and so on. Thus, FIG. 2 illustrates that passengers board the aircraft so that those who are assigned seats in the last row (i.e., row R29) board the aircraft first, with the passengers assigned the window seats (i.e., seats R29A and R29F) sitting down prior to those assigned the middle seats (i.e., seats R29B and R29E), who sit down prior to those assigned the aisle seats (i.e., seats R29C and R29D). After the passengers in row R29 board the aircraft, the passengers assigned seats in the next rear-most row (i.e., in the example shown, row R28) board the aircraft. The time period between when the passengers in the rear-most row (i.e., in this example, row R29) are sent on to the aircraft and when the passengers in the next-rear-most row (i.e., in this example, row R28) may be defined in any suitable fashion. For example, the passengers in the next-rear-most row may be cleared to board after the passengers in the rear-most row are seated, upon a predetermined amount of time passing after the passengers in the rear-most row enter the aircraft, or at any other suitable juncture.

After the passengers with assigned seats in the next-rear-most row (i.e., in this example, row R28) board the aircraft, they may sit in this row in an order similar to that described above (i.e., passengers assigned the window seats sit down first, followed by those assigned the middle seats, and then by those assigned the aisle seats). Passengers assigned seats in the remaining rows of the aircraft then board in a similar fashion. As discussed above, boarding the aircraft in this manner prevents delays associated with passengers having to wait in the aisle while a previously seated passenger gets up to allow them access to their seat. This method also allows groups of passengers sitting in contiguous blocks of seats to board the aircraft together.

It can be seen in FIG. 2 that there are no numbers in the icons for seats in rows R1-R5. This is because, in this example, these seat icons represent first-class seats, which airlines generally board prior to those assigned seats in rows R6-R29. However, it should be appreciated that embodiments of the invention are not limited to such an arrangement, and that passengers assigned seats in rows R1-R5 may board before, after or during the time that other passengers board the aircraft. Embodiments of the invention are not limited to any particular mode of implementation.

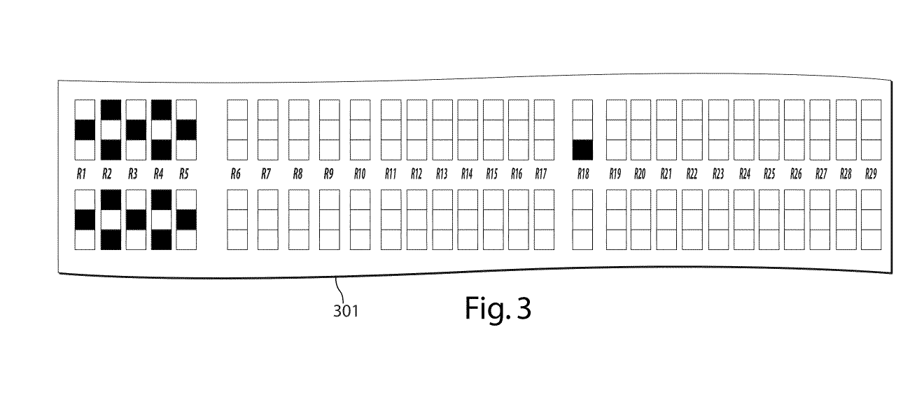

FIG. 3 depicts a representative physical article 301 that may be placed on the floor of a pre-boarding waiting area to assist in arranging passengers as they will be seated on an aircraft. As noted above, article 301 may take any of numerous forms, such as a drop cloth, rug, one or more laminated sheets, and/or any other suitable form.

The article depicted in FIG. 3 includes a box for each seat depicted in the seat map shown in FIG. 1, arranged in the same fashion as on the seat map. Thus, article 301 represents twenty-nine rows of seats, with six seats in each row except for one (i.e., row R18), and three seats on either side of the aisle. In some embodiments of the invention, passengers may stand on article 301 in the box corresponding to their assigned seat, so that when boarding is to commence, he/she may board the aircraft in the manner described above. Of course, a physical article need not use a box to depict a space corresponding to a seat on the aircraft. Any suitable shape may be shown.

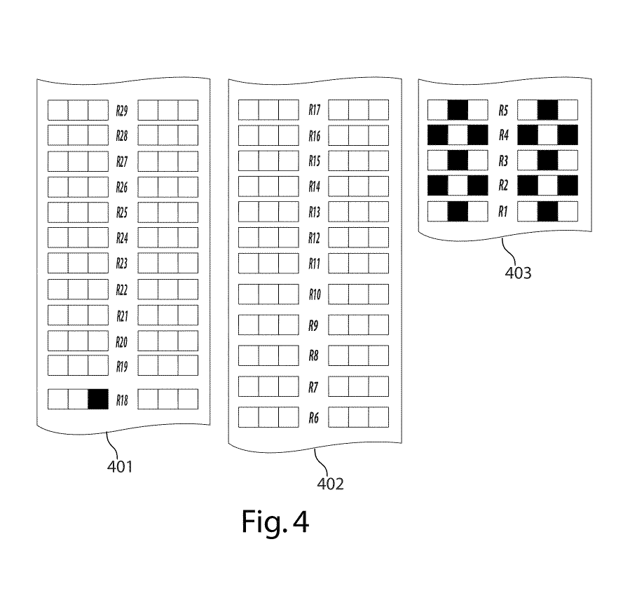

FIG. 4 depicts an alternative to the physical article shown in FIG. 3. Specifically, FIG. 4 depicts multiple articles 401A, 401B and 401C, each having boxes for different groups of seats on the aircraft. In the example shown, article 401A includes a box for each seat in rows R18-R29, article 401B includes a box for each seat in rows R6-R17, and article 401C includes a box for each seat in rows R1-R5. The use of multiple articles rather than a single article may afford advantages in certain circumstances. In this respect, the inventor has appreciated that in some airports, there may not be sufficient space in the pre-boarding waiting area for a single large physical article which depicts all of the seats on the aircraft to be placed on the floor. Multiple articles, however, may be arranged in a way that allows all of them to be laid out. Although three articles are depicted in FIG. 4, any suitable number may be used, as embodiments of the invention are not limited in this respect. Further, the articles may “break up” the seats of the aircraft in any suitable fashion. For example, the different articles need not break up the seats according to complete rows. Any suitable arrangement may be used.

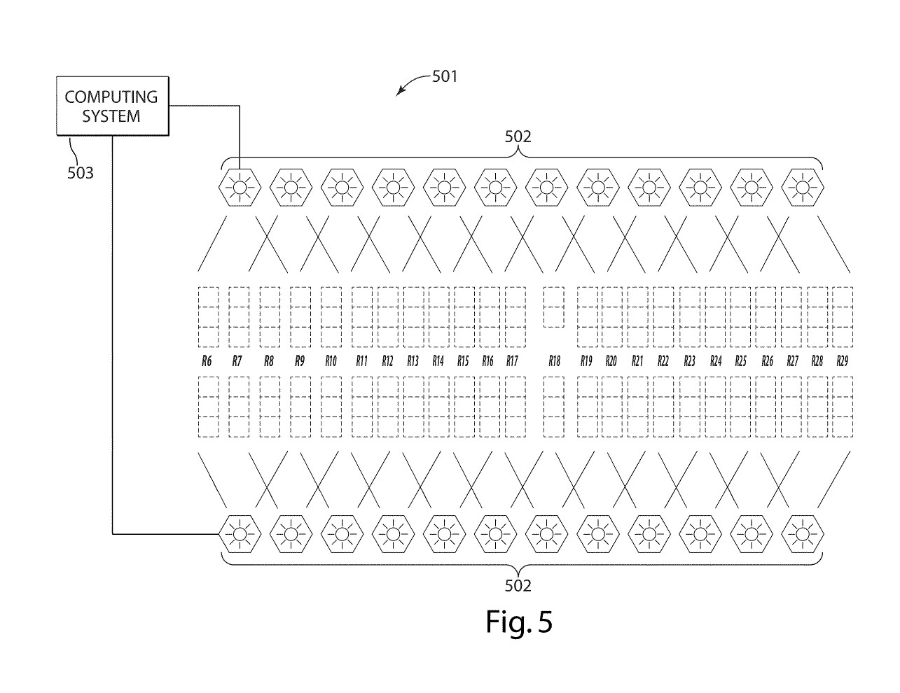

FIG. 5 depicts a representative lighting system 501 which emits a pattern of visible light toward the floor of the pre-boarding waiting area which represents the seats on an aircraft to be boarded. In the example shown in FIG. 5, the seats represented in the pattern are arranged in a manner similar to that which is shown on physical article 301 (FIG. 3), with twenty-nine contiguous rows of seats to be boarded, each row except for one having six seats, and each row having three seats on either side of the aisle. However, it should be appreciated that embodiments of the invention are not limited to generating a representation of any particular arrangement of seats, as any number of rows may be shown, each having any suitable number of seats, and any suitable number of seats on each side of the aisle. It should also be appreciated that lighting system 501 is not limited to displaying only a single representation of seats on an aircraft. For example, multiple different representations may be generated, each representing different blocks of seats on the aircraft. For example, projection system 501 could render multiple representations, with one showing the seats depicted by article 401A (FIG. 4), another showing the seats depicted by article 401B, and another showing the seats depicted by article 401C. Any suitable number of representations, each representing any suitable block of seats, may be projected.

Lighting system 501 includes lighting elements 502 which each emit light toward the floor of the pre-boarding waiting area from any suitable vantage point. For example, one or more of lighting elements 502 may be mounted to the ceiling, one or more may be mounted to a wall surface, one or more may be mounted within the floor itself, and one or more may be affixed to standalone lighting units. Any suitable arrangement may be employed.

In the example shown, a computing system 503 is employed to control lighting elements 502. For example, a computing system may control lighting elements 502 to render representations of different aircraft at different times. For example, a computing system may control lighting elements 502 to render a seat map on the floor of a pre-boarding waiting area for a first type of aircraft prior to the first aircraft being boarded, and then later, when a second type of aircraft is to be boarded, control lighting elements 502 to render a seat map for the second type of aircraft on the floor of the same pre-boarding waiting area.

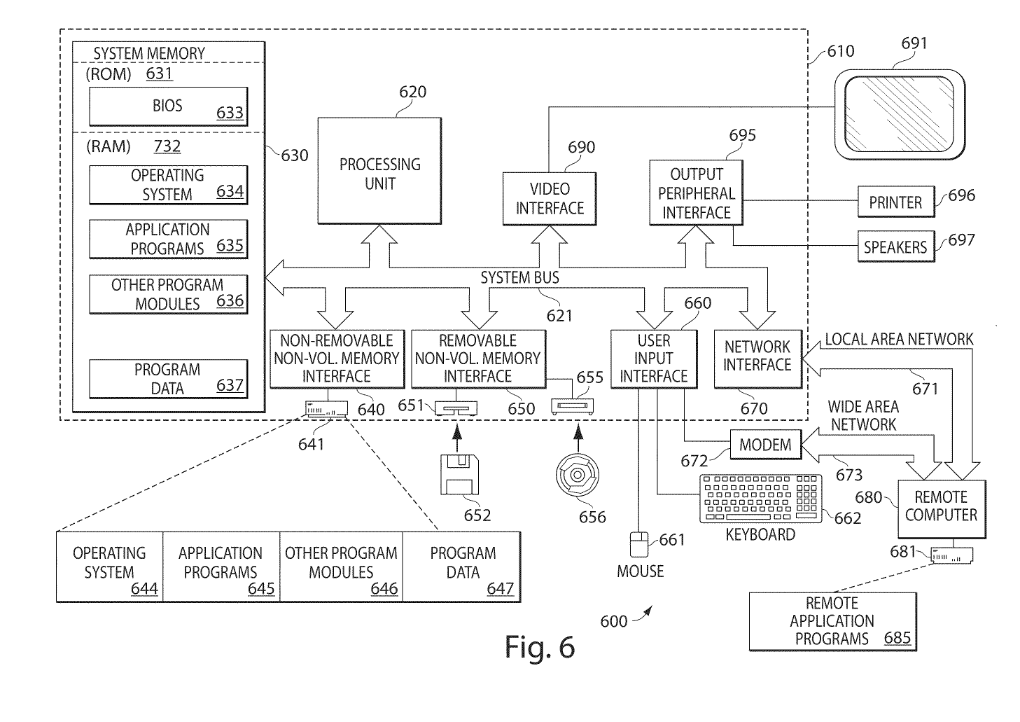

FIG. 6 illustrates one example of a suitable computing system environment 600 which may be used to control lighting elements 502. The computing system environment 600 is only one example of a suitable computing environment, and is not intended to suggest any limitation as to the scope of use or functionality of the invention. Neither should the computing environment 600 be interpreted as having any dependency or requirement relating to any one or combination of components illustrated in the exemplary operating environment 600. In this respect, embodiments of the invention are operational with numerous other general purpose or special purpose computing system environments or configurations. Examples of well-known computing systems, environments, and/or configurations that may be suitable for use with the invention include, but are not limited to, personal computers, server computers, mobile or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

FIG. 6 depicts a general purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media which may be used to store the desired information and may be accessed by computer 610. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through an non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 536, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 560 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through a output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Embodiments of the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a tangible machine, mechanism or device from which a computer may read information. Alternatively or additionally, the invention may be embodied as a computer readable medium other than a computer-readable storage medium. Examples of computer readable media which are not computer readable storage media include transitory media, like propagating signals.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The invention may be embodied as a method, of which an example has been described. The acts performed as part of the method may be ordered in any suitable way. Accordingly, embodiments may be constructed in which acts are performed in an order different than illustrated, which may include different acts than those which are described, and/or which may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of boarding passengers on an aircraft, the aircraft having a plurality of seats arranged in a plurality of seat rows, each of the passengers having been assigned one of the plurality of seats, the plurality of seat rows comprising a rear-most seat row that, among the plurality of seat rows, is closest to the rear of the aircraft and a front-most seat row that, among the plurality of seat rows, is closest to the front of the aircraft, the method comprising acts of:
(A) causing a population of passengers, constituting at least a majority of the passengers to be boarded on the aircraft before takeoff, to be physically arranged so that each passenger occupies one of a plurality of spaces, each of the spaces corresponding to one of the plurality of seats on the aircraft, the spaces being arranged in a plurality of rows, each of the plurality of rows corresponding to one of the seat rows on the aircraft, each of the spaces being located within one of the plurality of rows in a location similar to the location of the corresponding seat within the corresponding seat row on the aircraft;
(B) causing the passengers occupying the spaces corresponding to the seats in the rear-most seat row to board the aircraft;
(C) at a time subsequent to the time at which the act (B) commences, causing the passengers occupying the spaces corresponding to the seats in the next rear-most seat row to board the aircraft; and
(D repeating the act (C) until the population of passengers has boarded the aircraft.

2. The method of claim 1, wherein the act (A) comprises employing at least one physical article depicting the plurality of spaces to physically arrange the passengers.

3. The method of claim 1, wherein the act (A) comprises employing a light-emitting apparatus to emit visible light so as to define the plurality of spaces.

4. The method of claim 1, wherein the act (B) comprises causing the passengers occupying the spaces corresponding to the seats in the rear-most seat row to sit down in the aircraft so that any of the passengers assigned a window seat sit down first, any of the passengers assigned a middle seat sit down after the passengers assigned a window seat sit down, and any of the passengers assigned an aisle seat sit down after the passengers assigned a middle seat sit down.

5. At least one physical article for use in boarding passengers on an aircraft having a plurality of seats arranged in a plurality of seat rows, the at least one article comprising a representation portrayed thereon of each of the plurality of seats on the aircraft, the representations of the plurality of seats being arranged in a plurality of rows, each of the plurality of rows corresponding to one of the seat rows on the aircraft, each representation of a seat being located within one of the plurality of rows in a location similar to the location of the corresponding seat within the corresponding seat row on the aircraft;
wherein the at least one physical article has physical dimensions enabling a population of passengers, constituting at least a majority of the passengers to be boarded on the aircraft before takeoff, to be physically arranged so that each one of the population of passengers occupies a space corresponding to a representation of a seat which the one passenger is to occupy upon boarding the aircraft.

6. An apparatus for use in boarding passengers on an aircraft having a plurality of seats arranged in a plurality of seat rows, the apparatus comprising:
at least one light-emitting element configured to emit visible light toward a surface; and
at least one computer processor programmed to cause the at least one light-emitting element to emit light so as to define a plurality of spaces on the surface, each of the plurality of spaces corresponding to one of the plurality of seats on the aircraft, the plurality of spaces being arranged in a plurality of rows, each of the plurality of rows corresponding to one of the seat rows on the aircraft, each space being located within one of the plurality of rows in a location similar to the location of the corresponding seat within the corresponding seat row on the aircraft;
wherein the plurality of spaces have physical dimensions enabling a population of passengers, constituting at least a majority of the passengers to be boarded on the aircraft before takeoff, to be physically arranged so that each one of the population of passengers occupies a space corresponding to a seat which the one passenger is to occupy upon boarding the aircraft.

7. At least one computer-readable storage medium having instructions encoded thereon which, when executed, perform a method comprising an act of:
(A) causing at least one light-emitting element to emit visible light toward a surface so as to define a plurality of spaces on the surface, each of the plurality of spaces corresponding to one of the plurality of seats on an aircraft, the plurality of spaces being arranged in a plurality of rows, each of the plurality of rows corresponding to one of a plurality of seat rows on the aircraft, each space being located within one of the plurality of rows in a location similar to the location of the corresponding seat within the corresponding seat row on the aircraft;
wherein the plurality of spaces have physical dimensions enabling a population of passengers, constituting at least a majority of the passengers to be boarded on the aircraft before takeoff, to be physically arranged so that each one of the population of passengers occupies a space corresponding to a seat which the one passenger is to occupy upon boarding the aircraft.
